(19) United States
(12) Patent Application Publication
(10) Pub. No.: US 2019/0345717 A1
(43) Pub. Date: Nov. 14, 2019

(54) ONE-TOUCH TYPE COUPLER

(71) Applicants: Won Seog KANG, Seoul (KR); Ju Cheon SONG, Seoul (KR)

(72) Inventors: Won Seog KANG, Seoul (KR); Ju Cheon SONG, Seoul (KR)

(21) Appl. No.: 16/408,813

(22) Filed: May 10, 2019

(30) Foreign Application Priority Data
May 10, 2018 (KR) 10-2018-0053852

(51) Int. Cl. E04C 5/16; F16B 7/04

(52) U.S. Cl. CPC E04C 5/165; F16B 7/0426

(57) ABSTRACT

A one-touch type coupler for longitudinally interconnecting iron bars of the present disclosure includes a coupler housing, on both sides of which an iron bar fitting hole into which an iron bar is inserted is formed; a spring member, one side of which is seated on the inside of the iron fitting hole to apply elastic force and the radius of which is decreased gradually toward the insertion direction of the iron bar; a propping member which is seated on an upper end of the spring member and is composed of a seating part introduced toward an inner side of the spring member and a seating surface extending toward the outer radial direction from the upper circumference of the seating part by a predetermined length; a plurality of joining pieces which are seated on the propping member to surround the iron bar inserted into the inside of the iron bar fitting hole and a tapered first inclined surface is formed on an outer peripheral surface thereof; and a coupler cap, on the inside of which a tapered second inclined surface corresponding to the first inclined surface formed on the joining piece is formed and the inner diameter of which is decreased gradually toward the insertion direction of the iron bar, wherein a plurality of lengthwise grooves with a predetermined depth are formed on an inner peripheral surface of the joining pieces in a longitudinal direction of the joining piece at a predetermined interval so as to induce the surface contact with the lengthwise ribs formed on the iron bar, and a plurality of separation prevention protrusions, each of which is inclined at a predetermined angle are formed in the same direction with the direction of inserting the iron bar so as to induce the insertion of the iron bar between each of the plurality of lengthwise grooves and prevent the separation of the iron bar.

### CROSS-REFERENCE TO RELATED APPLICATION

This application claims under 35 U.S.C. § 119(a) the benefit of Korean Patent Application No. 10-2018-0053852 filed on May 10, 2018, which is hereby incorporated by reference.

### BACKGROUND

### Field of the Disclosure

The present disclosure relates to an one-touch type coupler, and more particularly, to a one-touch type coupler configured with a new structure that does not require a conventional O-ring for maintaining the position and shape of a joining piece and complements the durability of a support member for supporting the joining piece.

### Discussion of the Background

Generally, iron bars are widely used to reinforce the strength of concrete structures with being embedded in concrete when an iron bar concrete structure is applied in a field of a building or civil engineering, and especially, a large amount of iron bars are reinforced and used for a large structure, a special structure, and a civil engineering structure such as a bridge.

However, since iron bars are standardized and produced in a uniform length, the iron bars produced in a limited length need to be connected and used for a large building, a special structure, and a civil engineering structure such as a bridge.

Conventionally, iron bar connecting methods that have been used so far include a lap joint, a welding, a thread process, and a mechanical joint.

As the lap joint is a method in that the iron bars are overlapped each other to a predetermined length and joined by bundling them with steel wires or wires, it has a disadvantage in that since the iron bars need to be overlapped and joined every times, loss amount of iron is great, a strength of the overlapping portion is weak and easily separated, and a construction period is extended due to poor constructability. Further, the welding joints are difficult in construction and the strength of the iron bar around the welds is remarkably weakened by heat since the welds are heated.

Meanwhile, the coupler which has been tested by the present applicant is shown in FIGS. 11 to 13.

As described in the detailed description of the present disclosure below, in the case where the iron bars are inserted by using a support member 50 and then are actually used at a site, a phenomenon, where an extension part 60 of the support member 50 disposed between the joining pieces is damaged and broken, has occurred frequently.

Such damage is a fatal defect at the actual work site, and there has been a problem of stability, which could lead to a major accident.

Accordingly, the inventor of the present application has recognized such problems as described above and proposed a structure for supporting the joining piece with a simpler structure by supplementing the durability of the so-called support member 50.

Further, although the O-rings were used to maintain the positions or shapes of a plurality of the joining pieces in the related art, there have been problems in which the plurality of the joining pieces cannot be maintained in their positions or shapes due to wear of the O-rings and further the production cost of the O-rings themselves is incurred.

In addition, various protrusions or wrinkles formed on the inner side of the joining piece also have various problems such as failing to efficiently support the iron bars moving along the inner side of the joining piece.

The above information disclosed in this Background section is only for enhancement of understanding of the background of the disclosure and therefore it may contain information that does not form the prior art that is already known in this country to a person of ordinary skill in the art.

### SUMMARY

The present disclosure to provide a coupler with a new structure capable of securing durability as described above, prevention a safety accident in advance, and firmly fixing the iron bars in the coupler housing.

The present disclosure has been made in an effort to solve the above-described problems associated with prior art and provides a one-touch type coupler.

To this end, the present disclosure provides a one-touch type coupler for longitudinally interconnecting iron bars, comprising: a coupler housing 100 on both sides of which an iron bar fitting hole A into which an iron bar is inserted is formed; a spring member 200 one side of which is seated on the inside of the iron bar fitting hole A to apply elastic force and the radius of which is decreased gradually toward the insertion direction of the iron bar; a propping member 600 which is seated on an upper end of the spring member 200 and is composed of a seating part 610 introduced toward an inner side of the spring member 200 and a seating surface 620 extending toward the outer radial direction from the upper circumference of the seating part 610 by a predetermined length; a plurality of joining pieces 300 which are seated on the propping member 600 to surround the iron bar inserted into the inside of the iron bar fitting hole A and on an outer peripheral surface, a tapered first inclined surface B is formed; and a coupler cap 400 on the inside of which a tapered second inclined surface C corresponding to the first inclined surface B formed on the joining piece 300 is formed and the inner diameter of which is decreased gradually toward the insertion direction of the iron bar, wherein a plurality of lengthwise grooves (340) of a predetermined depth are formed on an inner peripheral surface of the joining pieces 300 in a longitudinal direction of the joining piece 300 at a predetermined interval so as to induce the surface contact with the lengthwise ribs formed on the iron bar, and a plurality of separation prevention protrusions 700 each of which is inclined at a predetermined angle are formed in the same direction with the direction of inserting the iron bar so as to induce the insertion of the iron bar between the plurality of lengthwise grooves 340 and prevent the separation of the iron bar.

### BRIEF DESCRIPTION OF THE DRAWINGS

The above and other features of the present disclosure will now be described in detail with reference to certain exemplary embodiments thereof illustrated the accompanying drawings which are given herein below by way of illustration only, and thus are not limitative of the present disclosure, and wherein:

FIG. 1 is an exploded perspective view illustrating a one-touch type coupler with an improved durability according to the present disclosure;

FIGS. 2(a) and 2(b) are a perspective photograph and a side photograph, respectively, of a spring member actually used in the present disclosure;

FIG. 3 is an actual photograph of a propping member actually used in the present disclosure;

FIG. 4 is an actual photograph in which the propping member is seated on the spring member;

FIG. 5 is a perspective view of the propping member;

FIG. 6(a) is an actual photograph in which one joining piece is positioned so as to be inclined toward the center thereof due to the structure of the seating surface;

FIG. 6(b) is an actual photograph in which four joining pieces are seated;

FIG. 7 is a view illustrating the joining piece which has been filed and registered for a patent by the present applicant;

FIG. 8(a) is a perspective view illustrating four joining pieces in contact with each other, which are one component of the present disclosure;

FIG. 8(b) is an enlarged view illustrating the separation prevention protrusions shown at “A” in FIG. 8(a);

FIG. 9 is a perspective view illustrating a coupler cap;

FIG. 10 is an inner side view illustrating the coupler cap;

FIGS. 11 to 13 are views illustrating the coupler tested by the present applicant;

FIG. 14 is a photograph of an iron bar used in an actual construction site;

FIG. 15 is an enlarged side view illustrating an inclined angle of the separation prevention protrusions; and

FIG. 16 is a view illustrating various structures of the lengthwise grooves.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

Hereinafter, the preferred embodiment of a one-touch type coupler with an improved durability according to the present disclosure will be described, referring to the accompanying drawings.

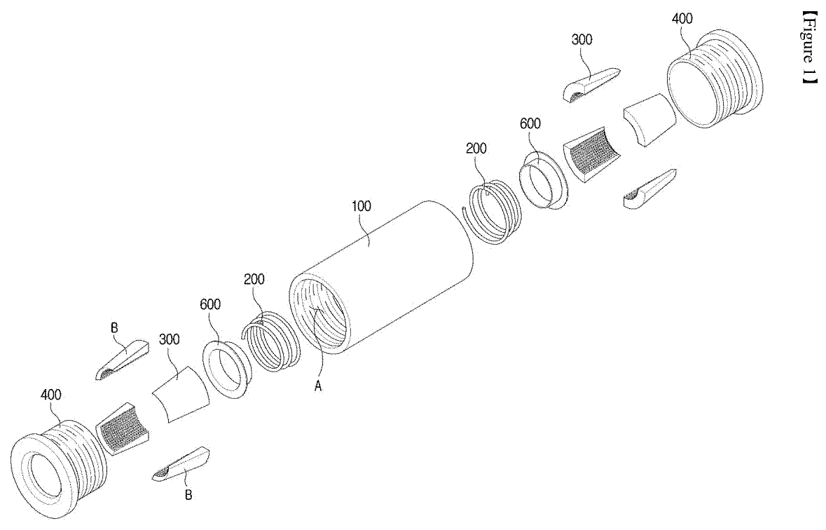

FIG. 1 is an exploded perspective view illustrating a one-touch type coupler with an improved durability according to the present disclosure.

As shown in the drawing, the present disclosure mainly includes a coupler housing 100, a spring member 200, a propping member 600, a joining piece 300, and a coupler cap 400.

In the coupler housing 100, an iron bar fitting hole A in which a predetermined space is provided is formed on both sides of the coupler housing so that the iron bars are inserted from both sides.

The coupler housing 100 may be preferably made of a metal material, an alloy, or a high-strength plastic material, but is not limited thereto.

Further, although the coupler housing is illustrated as a cylindrical shape in the drawings, it is not necessarily limited to such a shape, but can be implemented in various shapes according to the operator's choice.

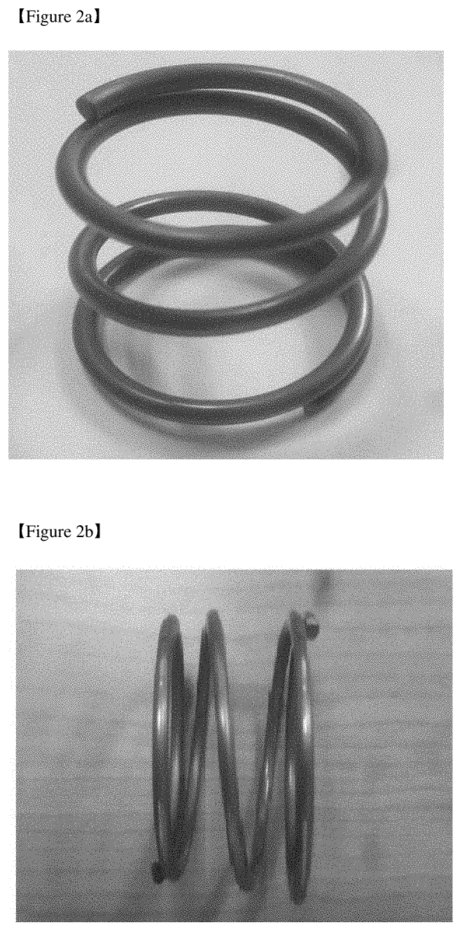

Meanwhile, FIGS. 2(a) and 2(b) are a perspective photograph and a side photograph, respectively, of a spring member 200 actually used in the present disclosure.

As shown in FIGS. 1 and 2, the spring member 200, one side of which is seated in the iron bar fitting hole A is provided to apply elastic force to the iron bar and a plurality of joining pieces 300, which will be described below.

The spring member 200 is characterized in that its radii at both ends are tapered to be different from each other.

More preferably, the spring member 200 is characterized in that its radius is gradually decreased in the direction in which the iron bars are inserted.

That is, the radius of the spring member 200 is formed to be gradually decreased to the left direction as shown in the drawing of FIG. 2(b).

The joining piece 300, which will be described later, is closely in contacted with an iron bar while surrounding an outer diameter of the iron bar wherein the direction of close contact is inclined toward an outer peripheral surface of the iron bar thereby to increase the tightness property and also the radius of the spring member 200 is formed to be gradually decreased toward the insertion direction of the iron bar so as to increase the tightness property of the joining piece 300.

According to the structure of the present disclosure, the tightness property of the iron bar is increased and the separation of the iron bar toward the outside is prevented, as compared with the conventional spring member 200 having a constant radius.

As described below in the operation processes of the present disclosure, in the case where the iron bar is inserted into the internal space formed by the internal sides of a plurality of joining pieces 300 which are seated on the propping member 600 to which the iron bar is fastened through the insertion into the upper end of the spring member 200, and then is pulled back, the spring member 200 applies elastic force to the plurality of joining pieces 300, thereby allowing the plurality of joining pieces 300 to move toward a coupler cap 400, which will be described later.

The plurality of joining pieces 300 and the coupler cap 400 are provided with inclined surfaces corresponding to each other, wherein the plurality of joining pieces 300 and the coupler cap 400 are in a surface contact by the inclined surfaces corresponding with each other while the plurality of the joining pieces 300 moves toward the coupler cap 400 so that the plurality of the joining pieces 300 are fixed at a predetermined point without further movement. In this state, the iron bar is fixed within a coupler housing 100 while the plurality of joining pieces 300 surrounds the outer peripheral surface of the iron bar.

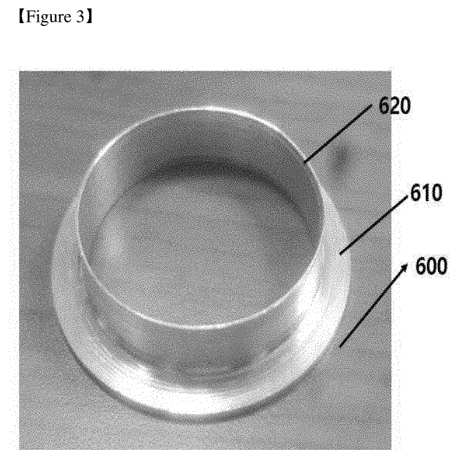

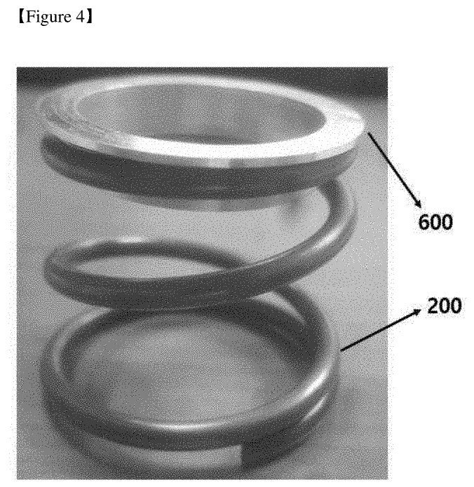

Meanwhile, FIG. 3 is an actual photograph of the propping member 600 actually used in the present disclosure, and FIG. 4 is an actual photograph in which the propping member 600 is seated on the spring member 200.

As shown in FIGS. 1 and 3, the propping member 600 is seated on the upper end of the spring member 200, and includes a seating part 610 which is introduced toward the inside of the spring member 200 and a seating surface 620 extending toward the outer radial direction from the upper circumference of the seating part 610 by a predetermined length.

The stability of the propping member 600 is secured through the seating part 610 and the joining pieces 300, which will be described later, is positioned on the seating surface 620.

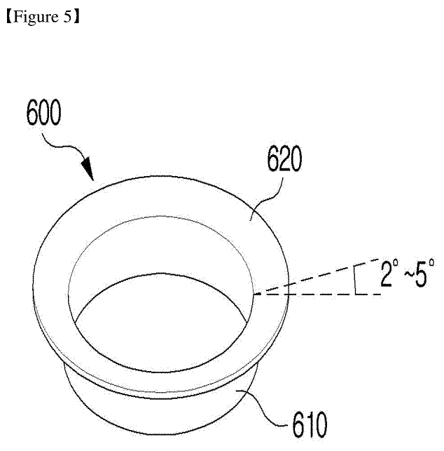

FIG. 5 is a perspective view illustrating the propping member 600.

Referring to FIGS. 3 to 5, the propping member 600 is formed with the seating surface 620 in a cylindrical shape with a hollow body and the seating part 610 extending to a predetermined length which can be inserted into the inner side of the spring member 200 downward along the circumference of inner diameter of the hollow body.

At this time, the seating surface 620 is inclined upward at a predetermined angle in the radial direction from the circumferential of inner diameter of the hollow body so that the plurality of the joining pieces 300 to be seated along the seating surface 620 can be positioned to be inclined toward the outer peripheral surface of the iron bar.

That is, the seating surface 620 is formed so as to be inclined upward from the center thereof to the outward direction so that the joining piece 300 seated on the seating surface 620 is formed to be inclined toward the iron bar which is introduced into the inside of the plurality of the joining pieces 300.

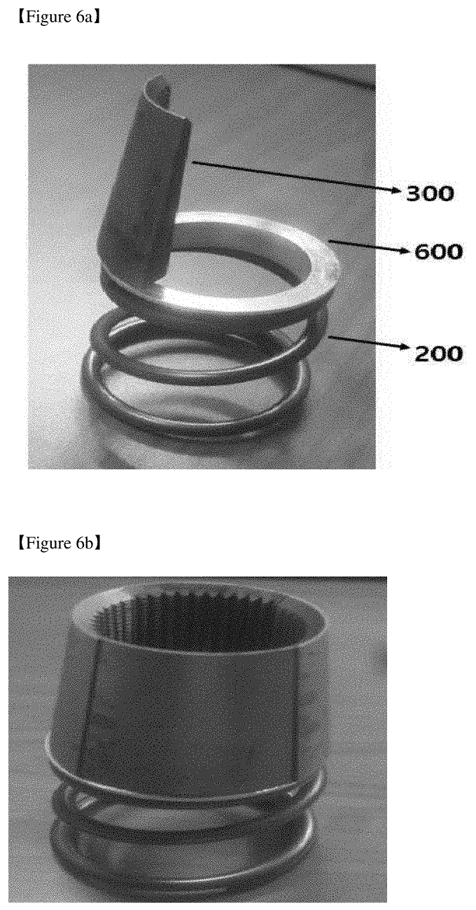

FIG. 6(a) is an actual photograph in which one joining piece 300 is positioned so as to be inclined toward its center by the structure of the seating surface 620, and FIG. 6(b) is the actual photograph in which four joining pieces 300 are seated.

According to a related art, an O-ring fastening groove 320 is formed on an outer peripheral surface of the joining piece 300 so as to maintain the positions of the plurality of the joining pieces 300 so that the joining piece 300 surrounds effectively the iron bar, and then the O-ring is fastened into the O-ring fastening groove 320 to maintain the form of the joining piece 300.

FIG. 7 is a view illustrating the joining piece 300 which has been filed and registered for a patent by the present applicant, and as shown in FIG. 7, an O-ring fastening groove 320 is formed on the outer peripheral surface of the joining piece 300 and then the O-ring is fastened to the O-ring fastening groove 320 so that an iron bar is inserted into the inside thereof while maintaining the shape of four joining pieces 300.

However, even if the O-ring is fastened, there is a limitation in that the iron bar is smoothly inserted into the inside of the joining pieces while maintaining the shape of the plurality of the joining pieces 300 and there is also a problem of the production cost of the O-ring itself. Further, it is obvious that the durability of the joining piece 300 is weakened due to the compression from the O-ring against the joining pieces 300. Therefore, it is designed in the present disclosure that durability of the joining piece is secured without using the O-ring and the iron bar is compressed effectively.

That is, the present disclosure is featured in the simplicity in comparison with the structure of the conventional coupler, such that the plurality of the joining pieces 300 can maintain their positions even without using the O-ring and the iron bar is compressed effectively by the joining pieces 300 by the following configurations: (1) the radius of the spring member 200 is gradually decreased toward the upper side as compared with the prior art; (2) the propping member 600 which is seated on the upper end of the spring member 200 is introduced instead of using the O-ring as in the prior art; and (3) the seating surface 620 constituting the propping member 600 is formed to be inclined upward in the outer direction rather than in the plane so that the joining piece 300 positioned on the seating surface 620 is inclined toward the outer radial direction of the iron bar.

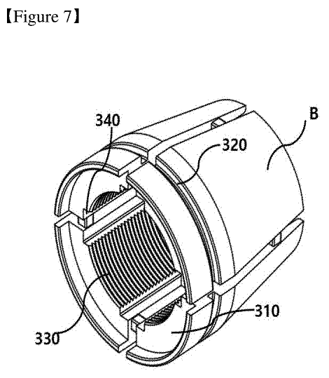

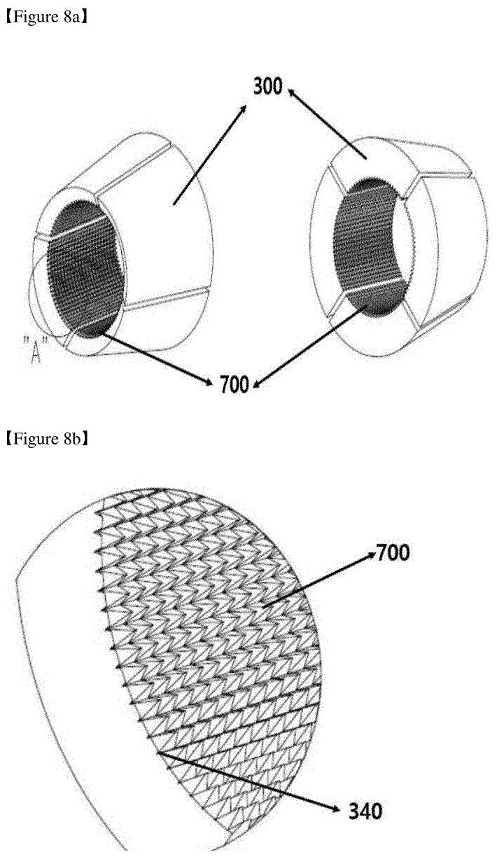

Meanwhile, FIG. 8(a) is a perspective view illustrating four joining pieces 300 in contact with each other which are one component of the present disclosure, and FIG. 8(b) is an enlarged view illustrating the separation prevention protrusions 700 shown at “A” in FIG. 8(a).

As already described simply, the joining piece 300 is seated on the propping member 600 to surround the iron bar inserted into the inside of the iron bar fitting hole A and a tapered first inclined surface B is formed on an outer peripheral surface thereof.

Four joining pieces 300 are shown in FIG. 1 and in the case where four joining pieces 300 are seated on the propping member 600, an iron bar is inserted into an internal space formed by the internal side surfaces of the four joining pieces 300.

At this time, as shown in FIG. 5, the seating surface 620 of the propping member 600 is inclined upwards at a predetermined angle in the radial direction from the circumference of inner diameter of a hollow body.

In the case where the inclined angle of the seating surface 620 is formed from more than 2° to less than 5°, it has been confirmed through a lot of tests conducted by the present applicant that the O-ring is not necessary to be used and fixes the iron bars most effectively.

As a result, the joining piece 300 which is seated on the propping member 600 is also obliquely positioned in the direction of the outer peripheral surface of the iron bar by the inclined angle of the propping member 600.

The inclined joining pieces 300 not only press the iron bars more efficiently as compared with the prior art, but also eliminate the need for a conventional O-ring used for maintaining the positions of the plurality of the joining pieces 300.

When the iron bar is inserted into the space of hollow formed by four joining pieces 300, the four joining pieces 300 are also separated each other while the spring member 200 is compressed.

When the inserted iron bar is pulled outward again, the four joining pieces 300 are moved toward the coupler cap 400, which will be described later, due to the elastic force of the spring member 200, and thereby the hollow space is gradually narrowed to compress the iron bar.

The coupler cap 400 and the four joining pieces 300 are formed with inclined surfaces corresponding to each other and the iron bar is not separated by the surface contact of the inclined surfaces even when the iron bar is pulled out.

Further, the spring member 200 is also configured such that the radius gradually decreases toward the upper side in comparison with the structure of the conventional coupler, so that the plurality of the joining pieces 300 can maintain their positions without using the O-ring and the iron bar is compressed efficiently by the joining pieces 300. Accordingly, the present disclosure is configured more simply and the iron bar is compressed more efficiently than the conventional coupler.

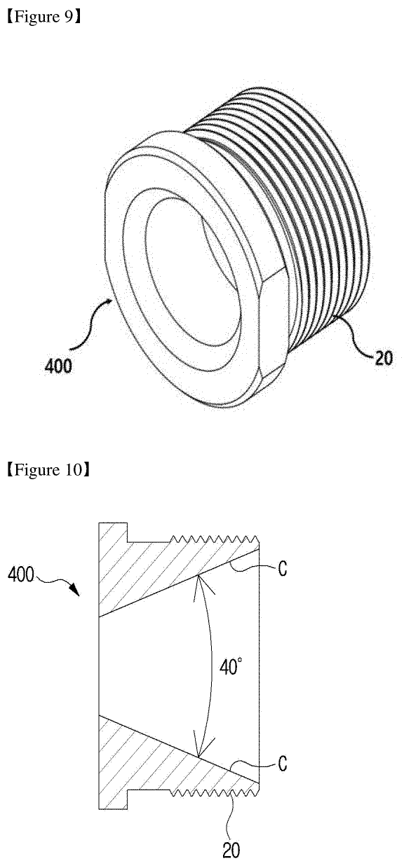

Meanwhile, FIG. 9 is a perspective view illustrating the coupler cap 400 and FIG. 10 is an internal side view illustrating the coupler cap 400.

As illustrated, a tapered second inclined surface C corresponding to the tapered first inclined surface B formed on the joining piece 300 is formed on the inner side of the coupler cap wherein the inner diameter thereof is formed to be gradually decreased in the direction to which the iron bar is inserted.

The first inclined surface B formed on the plurality of the joining pieces 300 and the second inclined surface C formed on the coupler cap 400 correspond to each other and the plurality of the joining pieces 300 are restricted from moving further to the coupler cap 400 side at a predetermined point by the surface contact of the first inclined surface B and the second inclined surface C, and as a result, the plurality of the joining pieces 300 fix the iron bar with surrounding the outer peripheral surface thereof.

Meanwhile, although the angle of the second inclined surface C is shown as 40° in FIG. 10, it is not limited thereto but may be variously set according to the inner diameter of the iron bar inserted at the construction site.

Hereinafter, the joining piece 300 will be described in detail.

Referring to FIG. 6(a) again, it shows an actual photograph of a state in which one of the plurality of the joining pieces 300 is seated on the propping member 600 fastened to the spring member 200.

According to a related art, a stepped groove 310 may also be formed in the joining piece 300 itself so as to be seated on the spring member 200. However, the present disclosure not only have the effect that the stepped groove 310 may be stably seated on the propping member 600 without the need of such a stepped groove 310 on the joining piece 300 itself, but also has a problem in that a stress is concentrated on the side of the stepped groove 310 in the case of the conventional joining piece 300 in which the stepped groove 310 is formed and thus cracks are generated on the joining piece 300 during actual construction.

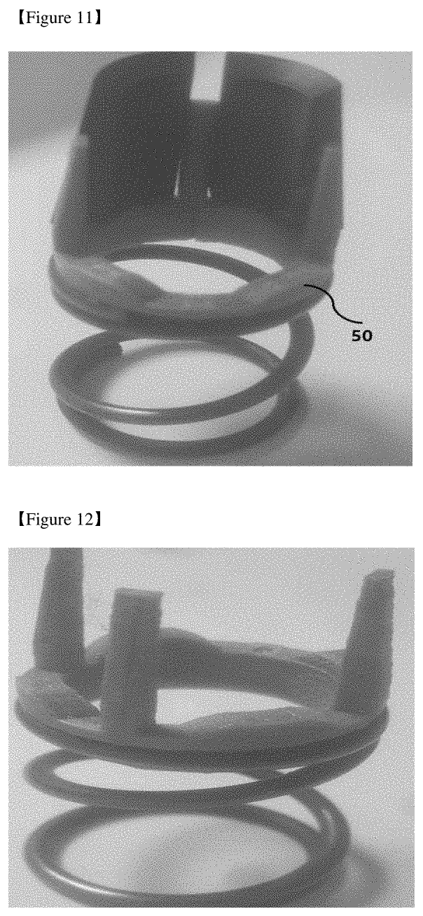

On the other hand, actual photographs of a conventional so-called support member 50 corresponding to the propping member 600 of the present disclosure are shown in FIGS. 11 to 13.

As shown in the drawings, in the case where a separate support member 50 is installed on an upper part of a spring to seat the joining piece 300 thereon, it is not necessary to form a separate space for seating on the joining piece 300.

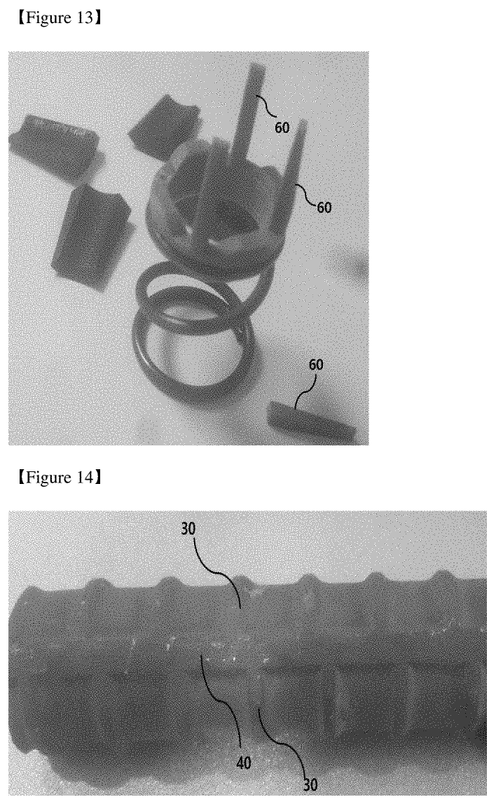

However, in the case where an iron bar is inserted using the support member 50 and then used at an actual site as shown in FIG. 13, a phenomenon that the extension part 60 of the support member 50, which is arranged between the joining pieces 300 is damage and broken occurred frequently.

The present disclosure provides a propping member 600 that does not require such an extension part 60, and thus it has an advantage that durability is improved as compared with the conventional art.

Such damage is a fatal defect in an actual construction site, and there has been a problem of stability such as it can lead to a major accident.

Accordingly, in the present disclosure, the joining piece 300 is seated stably through the propping member 600 which is inclined upwards at a predetermined angle only in the outer direction instead of the separate support member 50 which is tested by the present applicant.

In addition, each of the four joining pieces 300 are stably arranged at a predetermined positions by the support member 50 tested by the present applicant, as shown in FIGS. 11 to 13, to form a hollow space. However, since the support member 50 having a risk of breakage is not used in the present disclosure, there has been a need to stably seat the joining piece 300 on the propping member 600.

As described above, a separate O-ring has been used to maintain the positions of the plurality of the joining pieces 300 according to a related art. However, the present disclosure realizes an effect that the seating surface 620 of the propping member 600 is installed to be inclined upward at a predetermined angle so that the plurality of the joining pieces 300 are positioned to be inclined in the outer radial direction of the iron bar by this inclination angle to maintain the stability thereof.

As a result, even if the O-ring fastening groove 320 for fastening the O-ring and the stepped groove 310 to be seated on the spring member 200 are not provided in the joining piece 300 of the present disclosure, since the joining piece is seated stably on the spring member 200 through the propping member 600 and further it is not necessary to use the support member 50 which is tested by the applicant of the present disclosure, it is possible to realize various effects such as prevention of a safety problem in advance that may occur in an actual construction site.

Referring to FIG. 8(b) again, a plurality of lengthwise grooves 340 with a predetermined depth are formed at a predetermined interval on the inner peripheral surface of the joining piece 300 in a longitudinal direction of the joining piece 300 so as to induce the surface contact with the lengthwise ribs 400 formed on an iron bar.

FIG. 14 is a photograph of an iron bar structure used in an actual construction site.

As shown in the drawing, the lengthwise ribs 40 are formed on an iron bar in the longitudinal direction, and a plurality of circumferential ribs 30 are formed in the circumferential direction.

In order to prevent the decrease of insertion of the iron bar into the space formed by the plurality of joining pieces 300 by the lengthwise ribs 40 formed on the iron bar, it needs a space and a structure where the iron bar can be inserted effectively and positioned at an inner side of the joining piece 300.

For this purpose, a plurality of lengthwise grooves 340 with a predetermined depth are formed on the inner peripheral surface of the joining piece 300 at a predetermined interval in a longitudinal direction of the joining piece 300, thereby inducing the surface contact with the lengthwise ribs 40 formed on the iron bar.

Of course, although the separation prevention protrusions 700, which will be described below, may be formed on the inner surface of the joining piece 300 so that such a lengthwise groove 340 may inevitably be formed, there is an advantage that the frictional force with the iron bar is improved by the lengthwise groove 340 and the compressing to the iron bar by the joining piece 300 is further improved.

That is, the iron bar can be firmly fixed within the coupler housing 100 by the lengthwise grooves 340 formed on the joining piece 300 in comparison with the prior art as described above, and the conventional problem that the joining piece 300 cannot fix efficiently the iron bar by the lengthwise ribs 40 while surrounding the iron bar may be resolved.

In addition, the lengthwise grooves 340 have a rectangular or circular cross-section as shown in the cross-sectional view of FIG. 16, thereby dispersing the stress caused by the movement of the iron bar.

Meanwhile, in order to induce the insertion of iron bar between each of the plurality of lengthwise grooves 340 and prevent the separation of the iron bar, a plurality of the separation prevention protrusions 700 each of which is inclined at a predetermined angle in the same direction with the direction of inserting the iron bar are formed.

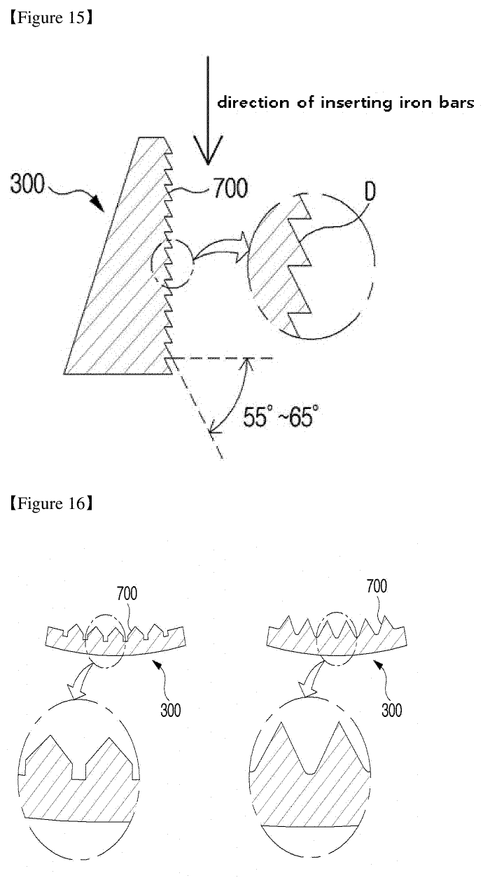

FIG. 15 is an enlarged side view illustrating an inclined angle of the separation prevention protrusions 700.

Referring to FIG. 8(b) and FIG. 15, the separation prevention protrusion will be described as follows.

The separation prevention protrusion 700 is composed of four slopes in a triangular shape which are formed downward around the vertex and one bottom surface in line contact with the base of four slopes wherein the slope D which contacts the insertion direction of the iron bar is inclined at a predetermined angle in the same direction with the direction of inserting the iron bar, and the remaining three slopes not in contact with the insertion direction of the iron bar are also inclined at a predetermined angle corresponding to the insertion direction of the iron bar.

The separation prevention protrusion 700 has a quadrangular pyramid shape and is characterized in that the inclined angle of the slope D which contacts the insertion direction of the iron bar (shown in FIG. 15) is 55° or more and 65° or less.

That is, a plurality of the separation prevention protrusions 700 are formed in the longitudinal direction of the joining piece 300 between each of the plurality of the lengthwise grooves 340, and are formed in a quadrangular pyramid shape as a whole.

The D slope of the separation prevention protrusion 700 having such a shape, which is positioned in the insertion direction of the iron bar, is inclined at a predetermined angle in the same direction with the direction of inserting the iron bar so that the iron bar can be easily inserted therein.

This inclined surface allows the iron bar to be inserted easily and does not allow the iron bar to be pulled out when the iron bar is pulled out in the direction opposite to the inserted direction.

Of course, the three slopes other than the plane D which contacts the insertion direction of the iron bar are formed to be inclined correspondingly, and preferably the inclination angle of the surface which contacts the insertion direction of the iron bar is 55° or more and 65° or less.

However, it was confirmed that the optimum angle through actual tests was 60°, but this can also be changed depending on the working environment and the shape of the iron bar to be inserted.

Although not shown in the drawing, the separation prevention protrusion 700 may be formed in a triangular pyramid shape wherein three slopes in a triangular shape are formed downward around the vertex and one bottom surface is in line contact with the base of three slopes.

Meanwhile, the coupler housing 100 has a hollow cylindrical shape, in which a separation membrane, not shown in the drawings, on which the spring member 200 can be seated is formed, and a plurality of first screw threads are formed on the inner side surface thereof.

Hereinafter, the operating relationship of the present disclosure will be schematically described.

The propping member 600 is seated on an upper end of the spring member 200 prior to the insertion of the iron bar and the spring member 200 on which the propping member 600 is seated is positioned on the separation membrane of the coupler housing 100.

Next, the plurality of the joining pieces 300 are positioned on the seating surface 620 of the propping member 600, wherein no O-ring is required to maintain the positions of the plurality of joining pieces 300.

Even in a state in which no O-ring is required, the joining pieces can maintain their positions while forming a predetermined space on the inside formed by inner surfaces of the plurality of the joining pieces 300.

At this time, since the seating surface 620 is inclined outward at a predetermined angle, the plurality of the joining pieces 300 are also positioned to be inclined obliquely toward the iron bar.

In subsequent, when the iron bar is inserted into the space formed by the plurality of the joining pieces 300, the plurality of the joining pieces 300 are separated as the radius of the space formed by the plurality of the joining pieces 300 increases and then the iron bar is moved to the inside. Thereafter, in the case where the iron bar is pulled back or the coupler housing is pulled toward the direction of inserting the iron bar, the plurality of the joining pieces 300 moves upward and compresses the iron bar as the radius of the space formed by the plurality of the joining pieces 300 becomes smaller and narrower.

Of course, it is obvious that the coupler cap 400 is coupled in advance before inserting the iron bar, and then the iron bar may be inserted.

The first inclined surface B and the second inclined surface C, corresponding to each other, are formed on the plurality of the joining pieces 300 and the coupler cap 400, and thus the plurality of the joining pieces 300 are not raised no more and fixed at a predetermined position after the each inclined surface is in surface contact with each other.

In addition, since the plurality of the separation prevention protrusions 700 which are inclined in the direction opposite to the direction in which the iron bar is pulled out are formed on an inner side surface of the joining piece 300 to prevent the iron bar from being pulled out, thereby further improving the effect of fixing the iron bar in comparison with the prior art.

Through this operation, the iron bar is fixed to the coupler without being pulled out any further.

According to the configuration and operation of the present disclosure as described above, various effects are realized as compared with a conventional coupler tested by the present applicant, such that so-called separate support member 50 is not necessary and also the extension part 60 of the support member 50 is not broken due to the friction with the iron bar and the weight of the iron bar when using the coupler at an actual construction site, thereby solving the problem of the stability.

When the one-touch type coupler of the present disclosure having the above-described structure is used, various effects can be realized, such that it is possible to complement the durability of the support member, solve the problem of safety accident because there is no fear that the extension part of the support member is broken by friction or load with the iron bar when used at the actual work site, and couple the iron bars to each other in the coupler housing much better than the conventional ones by the separation prevention protrusions, which is a unique structure formed on the joining piece for supporting while surrounding the iron bars.

It will be apparent to those skilled in the art that various modifications and variations can be made in the present disclosure without departing from the spirit or scope of the disclosure. The present disclosure is not limited to the drawings.

What is claimed is:

1. A one-touch type coupler for longitudinally interconnecting iron bars, comprising:
a coupler housing, on both sides of which an iron bar fitting hole into which an iron bar is inserted is formed;
a spring member one side of which is seated on the inside of the iron bar fitting hole A to apply elastic force and the radius of which is decreased gradually toward the insertion direction of the iron bar;
a propping member which is seated on an upper end of the spring member and is composed of a seating part introduced toward an inner side of the spring member and a seating surface extending toward the outer radial direction from the upper circumference of the seating part by a predetermined length;
a plurality of joining pieces which are seated on the propping member to surround the iron bar inserted into the inside of the iron bar fitting hole and on an outer peripheral surface a tapered first inclined surface is formed; and
a coupler cap on the inside of which a tapered second inclined surface corresponding to the first inclined surface formed on the joining piece is formed and the inner diameter of which is decreased gradually toward the insertion direction of the iron bar,
wherein a plurality of lengthwise grooves with a predetermined depth are formed on an inner peripheral surface of the joining pieces in a longitudinal direction of the joining piece at a predetermined interval so as to induce the surface contact with the lengthwise ribs formed on the iron bar, and
a plurality of separation prevention protrusions, each of which is inclined at a predetermined angle are formed in the same direction with the direction of inserting the iron bar so as to induce the insertion of the iron bar between each of the plurality of lengthwise grooves and prevent the separation of the iron bar.

2. The one-touch type coupler of claim 1, wherein the propping member comprises a seating surface formed in a circular shape of a hollow body and a seating part extending downward along the circumference of inner diameter of the hollow body to a predetermined length which is inserted into the inside of the spring member, and
wherein the seating surface is inclined upward at a predetermined angle in a radial direction from the circumference of inner diameter of the hollow body so that the plurality of joining pieces seated along the seating surface can be positioned to be inclined at a predetermined angle toward an outer peripheral direction of the iron bar.

3. The one-touch type coupler of claim 1, wherein the separation prevention protrusion is composed of four slopes in a triangular shape which are formed downward around the vertex and one bottom surface in line contact with the base of four slopes, and
wherein the slope, which contacts the direction of inserting the iron bar, is inclined at a predetermined angle in the same direction with the direction of inserting the iron bar, and the remaining three slopes which are not in contact with the insertion direction of the iron bar are also inclined at a predetermined angle corresponding to the inserting direction of the iron bar.

4. The one-touch type coupler of claim 1, wherein the separation prevention protrusion is composed of a triangular pyramid in which three slopes in a triangular shape are formed downward around the vertex and one bottom surface is in line contact with the base of three slopes, respectively, and
the slope, which contacts the insertion direction of the iron bar, is inclined at a predetermined angle in the same direction with the direction of inserting the iron bar, and the remaining three slopes which does not contact the insertion direction of the iron bar are also inclined at a predetermined angle corresponding to the direction of inserting the iron bar.

5. The one-touch type coupler of claim 3, wherein the separation prevention protrusion has a quadrangular pyramid shape and the inclined angle of the slope which contacts the insertion direction of the iron bar is 55° or more and 65° or less.

6. The one-touch type coupler of claim 1, wherein the coupler housing has a hollow body in a cylindrical shape, in which a separation membrane is formed and on an inner side surface of which a plurality of first screw threads are formed.

7. The one-touch type coupler of claim 1, wherein the spring member has one side seated on the inside of the iron bar fitting hole to apply elastic force and is tapered to have different radii at both ends thereof.
